(19) United States
(12) Patent Application Publication
(10) Pub. No.: US 2011/0302520 A1
(43) Pub. Date: Dec. 8, 2011

(54) IMAGE READING APPARATUS, IMAGE PROCESSING METHOD, AND COMPUTER PROGRAM PRODUCT

(75) Inventors: Tomonori YUASA, Ishikawa (JP); Yoshiyuki MURAKAMI, Ishikawa (JP); Yoshiki NAKAMURA, Ishikawa (JP)

(73) Assignee: PFU LIMITED, Ishikawa (JP)

(21) Appl. No.: 12/916,113

(22) Filed: Oct. 29, 2010

(30) Foreign Application Priority Data
Jun. 3, 2010 (JP) 2010-127739

(51) Int. Cl. G06F 3/048

(52) U.S. Cl. 715/773

(57) ABSTRACT

An image reading apparatus includes a touch panel, a storage unit, and a control unit, wherein the control unit includes a screen displaying unit that displays, on the touch panel, a screen area containing a text input area, wherein user input is possible, and a keyboard displaying unit that displays, when the user performs an operation of selecting the text input area via the touch panel, a part of the screen area containing the selected text input area and a keyboard screen on the touch panel.

### BACKGROUND OF THE INVENTION

1. Field of the Invention

The present invention relates to an image reading apparatus, an image processing method, and a computer program product.

2. Description of the Related Art

In some conventional image processing apparatuses, when a character string is to be input, a software keyboard is displayed on a touch panel in a screen layout based on the premise of the input, and then a user is allowed to input the character string.

For example, in an image forming apparatus disclosed in JP-A-11-133816, a technology is disclosed in which a position of a specified character input portion is acquired to make a setting so that a virtual keyboard can be displayed at a position where display of the character input portion is not interfered on an LCD (Liquid Crystal Display) screen.

In an electronic file apparatus disclosed in JP-A-6-119393, a technology is disclosed in which, in a screen displayed after a box is selected and then “name or rename box name” in a box confirmation window is selected, a software keyboard window is displayed on the bottom part of the screen.

In a network scanner apparatus disclosed in Japanese Patent No. 4,272,015, a technology is disclosed in which a file-name input screen is popped up for display on a read-condition specification screen by operating a file-name input instruction button in a file-format specification screen.

In typical conventional image processing apparatuses, a software keyboard is displayed at a predetermined position in a superimposed manner without performing field segmentation on a display screen, and every time the focus on an input field is moved depending on an input operation or the like by the user, the screen is scrolled to be re-displayed so that the input field can be laid out in the center of the screen.

However, in the conventional image processing apparatuses (JP-A-11-133816, JP-A-6-119393, and Japanese Patent No. 4,272,015), there is a problem in that when a character input target area (text input area) and a keyboard screen that enables an input operation are simultaneously displayed, it is impossible to provide a display that allows a user to easily perform the input operations.

In the conventional image processing apparatuses, because the screen is switched and re-displayed every time the input field is moved, there is a problem in that flickering occurs on the displayed screen, so that the screen is extremely poorly visible to a user.

### SUMMARY OF THE INVENTION

It is an object of the present invention to at least partially solve the problems in the conventional technology.

An image reading apparatus according to one aspect of the present invention includes a touch panel, a storage unit, and a control unit, wherein the control unit includes a screen displaying unit that displays, on the touch panel, a screen area containing a text input area, wherein user input is possible, and a keyboard displaying unit that displays, when the user performs an operation of selecting the text input area via the touch panel, a part of the screen area containing the selected text input area and a keyboard screen on the touch panel.

An image processing method according to another aspect of the present invention is executed by an image reading apparatus including a touch panel, a storage unit, and a control unit, wherein the method including a screen displaying step of displaying, on the touch panel, a screen area containing a text input area, wherein user input is possible, and a keyboard displaying step of displaying, when the user performs operation of selecting the text input area via the touch panel, a part of the screen area containing the selected text input area and the keyboard screen on the touch panel, wherein the steps are executed by the control unit.

A computer program product having a computer readable medium according to still another aspect of the present invention includes programmed instructions for an image processing method executed by an image reading apparatus including a touch panel, a storage unit, and a control unit, wherein the instructions, when executed by a computer, cause the computer to execute a screen displaying step of displaying, on the touch panel, a screen area containing a text input area, wherein user input is possible, and a keyboard displaying step of displaying, when the user performs operation of selecting the text input area via the touch panel, a part of the screen area containing the selected text input area and the keyboard screen on the touch panel, wherein the steps are executed by the control unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart of a basic principle of an embodiment;

FIG. 2 is a block diagram of an example of a configuration of an image reading apparatus to which the embodiment is applied;

FIG. 3 is a flowchart of an example of processing performed by the image reading apparatus according to the embodiment;

FIG. 4 is a diagram of an example of a display screen according to the embodiment;

FIG. 5 is a diagram of an example of the display screen according to the embodiment;

FIG. 6 is a conceptual diagram of an example of field segments in a screen area according to the embodiment;

FIG. 7 is a diagram of an example of a display area corresponding to each range of coordinates of a text input area according to the embodiment;

FIG. 8 is a diagram of an example of the display

FIG. 9 is a diagram of an example of the display screen according to the embodiment;

FIG. 10 is a flowchart of an example of processing performed by the image reading apparatus according to the embodiment;

FIG. 11 is a diagram of an example of the display screen according to the embodiment;

FIG. 12 is a diagram of an example of the display screen according to the embodiment; and

FIG. 13 is a diagram of an example of the display screen according to the embodiment.

### DETAILED DESCRIPTION OF THE PREFERRED EMBODIMENTS

An embodiments of an image reading apparatus, an image processing method, and a computer program product according to the present invention will be explained in detail below based on the drawings. The embodiment does not limit the invention.

[Outline of the Embodiment of the Present Invention]

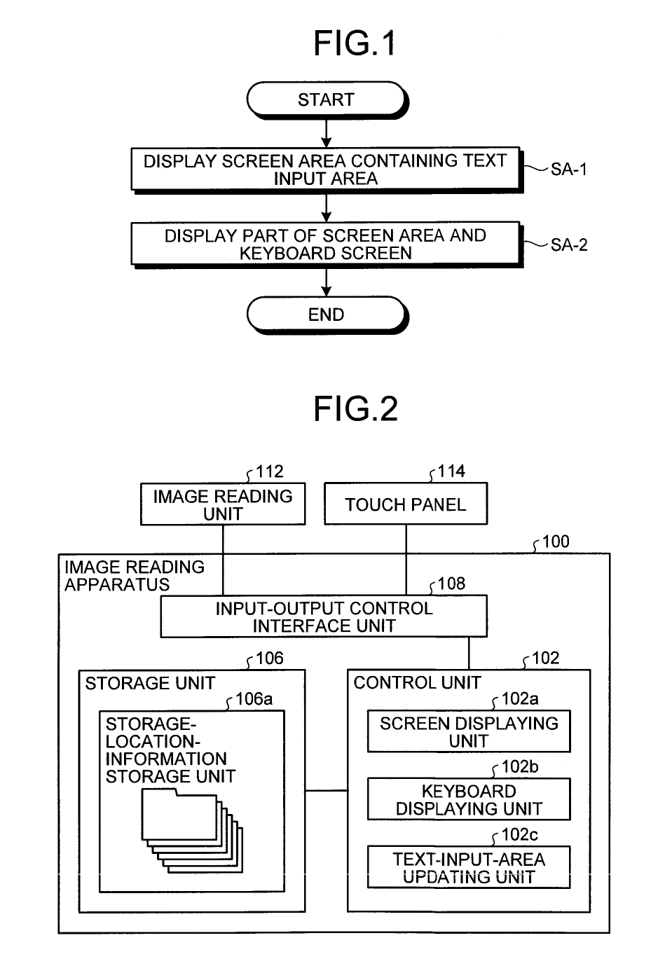

The outline of an embodiment of the present invention is explained below with reference to FIG. 1, and thereafter, configurations, processing, and the like of the embodiment are explained in detail. FIG. 1 is a flowchart of a basic principle of the embodiment.

The embodiment has following basic features in general. That is, as shown in FIG. 1, a control unit of an image reading apparatus according to the embodiment displays on a touch panel a screen area containing a text input area in which user input is possible (Step SA-1).

When the user performs an operation of selecting the text input area via the touch panel, the control unit of the image reading apparatus displays a part of the screen area containing the selected text input area and a keyboard screen on the touch panel (Step SA-2).

[Configuration of an Image Reading Apparatus 100]

The configuration of the image reading apparatus 100 is explained below with reference to FIG. 2. FIG. 2 is a block diagram of an example of a configuration of the image reading apparatus 100 to which the embodiment is applied. Only components related to the embodiment are schematically shown in the figure from among components in the configuration.

In FIG. 2, the image reading apparatus 100 generally includes a control unit 102, an input-output control interface unit 108, a storage unit 106, an image reading unit 112, and a touch panel 114. The control unit 102 is a CPU (Central Processing Unit) or the like that performs overall control on the whole image reading apparatus 100. The input-output control interface unit 108 is an interface connected to the image reading unit 112 and the touch panel 114. The storage unit 106 is a device for storing various databases, tables, or the like. Each unit of the image reading apparatus 100 is communicably connected to one another via any communication channels. Furthermore, the image reading apparatus 100 may be communicably connected to a network via a communication device, such as a router, and a wired communication line or a wireless communication means such as a dedicated line.

The various databases and tables (a storage-location-information storage unit 106a) stored in the storage unit 106 are storage unit such as fixed disk devices. For example, the storage unit 106 stores therein various programs, tables, files, databases, web pages, and the like used in various processing.

Among the components included in the storage unit 106, the storage-location-information storage unit 106a is a storage-location-information storage unit that stores storage location information related to a storage location of an image file of a document read by the image reading unit 112. Here, the storage location is a location for sorting and organizing data, such as files, on a computer, and may be, for example, a drawer, a binder, a directory, a folder, or the like.

In FIG. 2, the input-output control interface unit 108 controls the image reading unit 112 and the touch panel 114. A scanner, a digital camera, a web camera, or the like can be used as the image reading unit 112.

In FIG. 2, the control unit 102 includes an internal memory for storing a control program such as an OS (Operating System), programs that define various processing procedures, and necessary data. The control unit 102 performs information processing for executing various processing by these programs or the like. The control unit 102 functionally and conceptually includes a screen displaying unit 102a, a keyboard displaying unit 102b, and a text-input-area updating unit 102c.

Among these units, the screen displaying unit 102a is a screen displaying unit that displays, on the touch panel 114, a screen area containing a text input area, wherein user input is possible. The screen area may be made up of divided screen areas, wherein the divided screen areas are obtained by dividing the screen area into a plurality of areas. Furthermore, a part of the screen area may be a divided screen area. In a device having a small screen display area such as a built-in device, the divided screen areas may be set by dividing the screen area into three display zones, i.e., a top zone, a center zone, and a bottom zone. That is, the screen displaying unit 102a may display on the touch panel 114 a part of the screen area (divided screen area) containing the text input area in which user input is possible.

The keyboard displaying unit 102b is a keyboard displaying unit that displays, when the user performs an operation of selecting the text input area via the touch panel 114, a part of the screen area containing the selected text input area and a keyboard screen on the touch panel 114. When the user performs the operation of selecting the text input area via the touch panel 114, the keyboard displaying unit 102b may display the part of the screen area containing the selected text input area on the top part of the touch panel 114, and the keyboard screen on the bottom part of the touch panel 114, in an aligned manner. Furthermore, when the user performs the operation of selecting the text input area via the touch panel 114, the keyboard displaying unit 102b may display the part of the screen area containing the selected text input area on the top part of the touch panel 114 and the keyboard screen on the bottom part of the touch panel 114 in an aligned manner, wherein transition states of each screen area are continuously displayed until each screen area are placed on the respective predetermined position. Moreover, when the user performs the operation of selecting the text input area via the touch panel 114, the keyboard displaying unit 102b may display the part of the screen area containing the selected text input area and a translucent keyboard screen on the touch panel 114.

The text-input-area updating unit 102c is a text-input-area updating unit that updates, when character information is input by using the keyboard screen via the touch panel 114, the display of the text input area with the character information.

[Processing Performed by the Image Reading Apparatus 100]

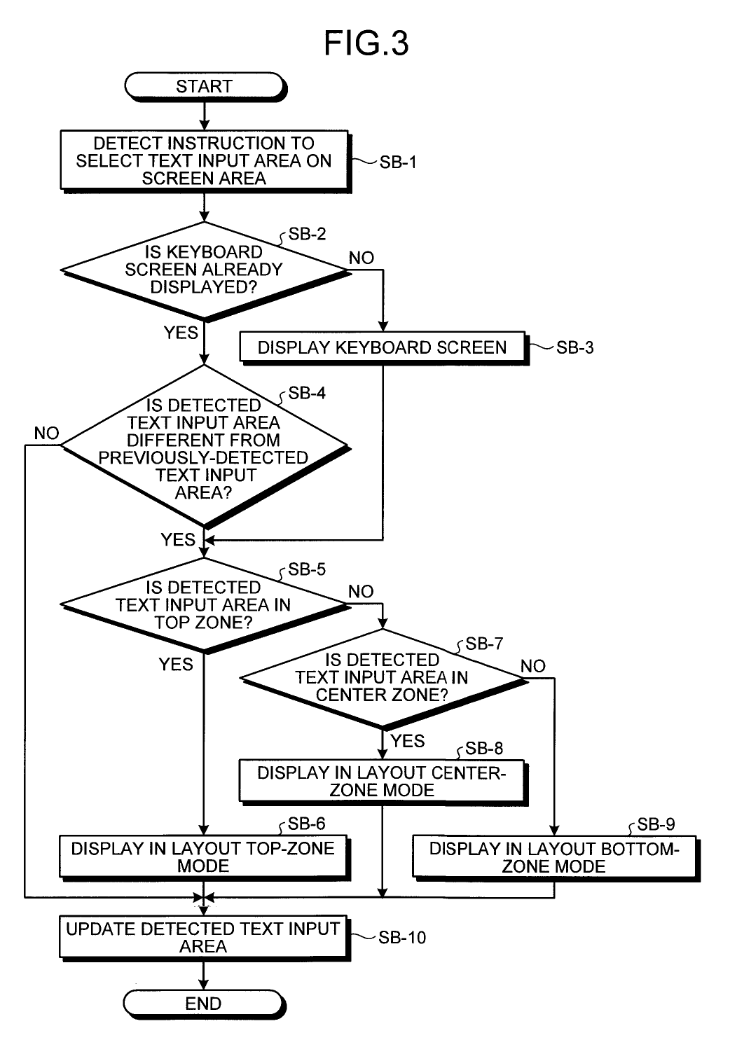

An example of processing performed by the image reading apparatus 100 having the above configuration according to the embodiment is explained in detail below with reference to FIGS. 3 to 13.

[First Processing]

First, an example of processing performed by the image reading apparatus 100 according to the embodiment when an electronic mail (e-mail) of an image file is transmitted is explained in detail below with reference to FIGS. 3 to 9. FIG. 3 is a flowchart of an example of processing performed by the image reading apparatus 100 according to the embodiment.

As shown in FIG. 3, when a user performs, via the touch panel 114, an operation (e.g., a tap operation) of selecting a text input area (text input field) on an e-mail transmission screen area (operation screen) displayed on the touch panel 114 by the screen displaying unit 102a, the control unit 102 detects an instruction to select the text input area (Step SB-1).

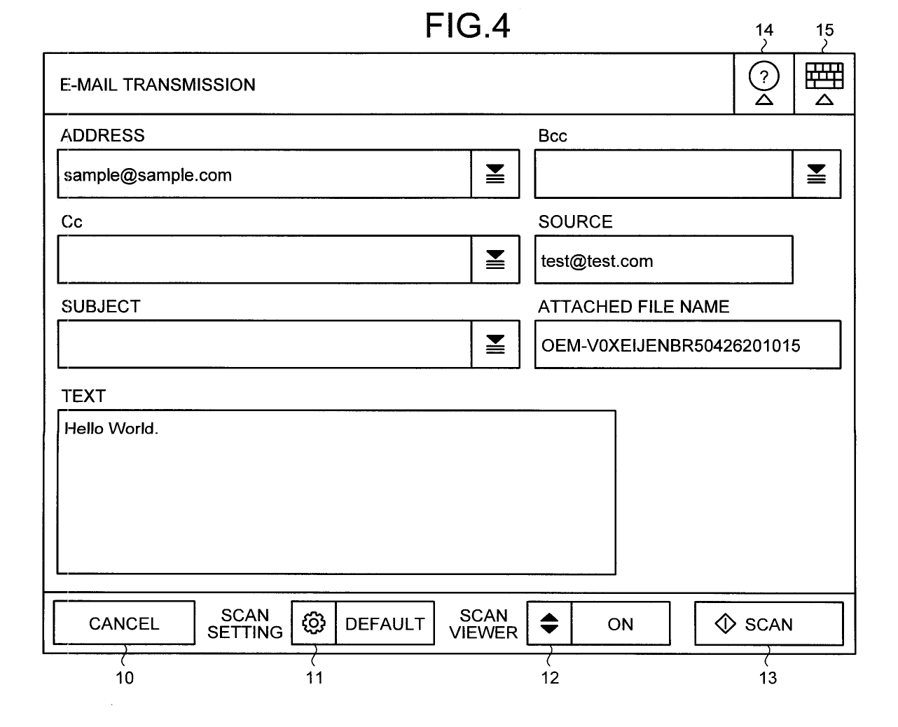

An example of the e-mail transmission screen area displayed by the screen displaying unit 102a according to the embodiment is explained in detail below with reference to FIG. 4. FIG. 4 is a diagram of an example of the display screen according to the embodiment.

As shown in FIG. 4, the screen displaying unit 102a displays on the touch panel 114 a screen area containing text input areas (address, Cc (carbon copy), Bcc (blind carbon copy), source, subject, attached file name, and text), a scan cancel icon 10, a scan setting selector icon 11, a scan viewer selector icon 12, and a scan start icon 13 as well as a help icon 14 and a keyboard screen display icon 15. In the text input areas of “address”, “Cc”, “Bcc”, and “source”, character information on an e-mail address may be input. Furthermore, in the text input area of “attached file name”, character information on a file name of an image file (scan data) that is of a document read by the image reading unit 112 and that is attached when the e-mail is transmitted may be input.

Referring back to FIG. 3, the control unit 102 determines whether the keyboard screen (software keyboard) is already displayed on the touch panel 114 by the keyboard displaying unit 102b (Step SB-2).

When the control unit 102 determines at Step SB-2 that the keyboard screen is not displayed on the touch panel 114 (NO at Step SB-2), the keyboard displaying unit 102b displays the keyboard screen on the bottom part of the touch panel 114 (Step SB-3).

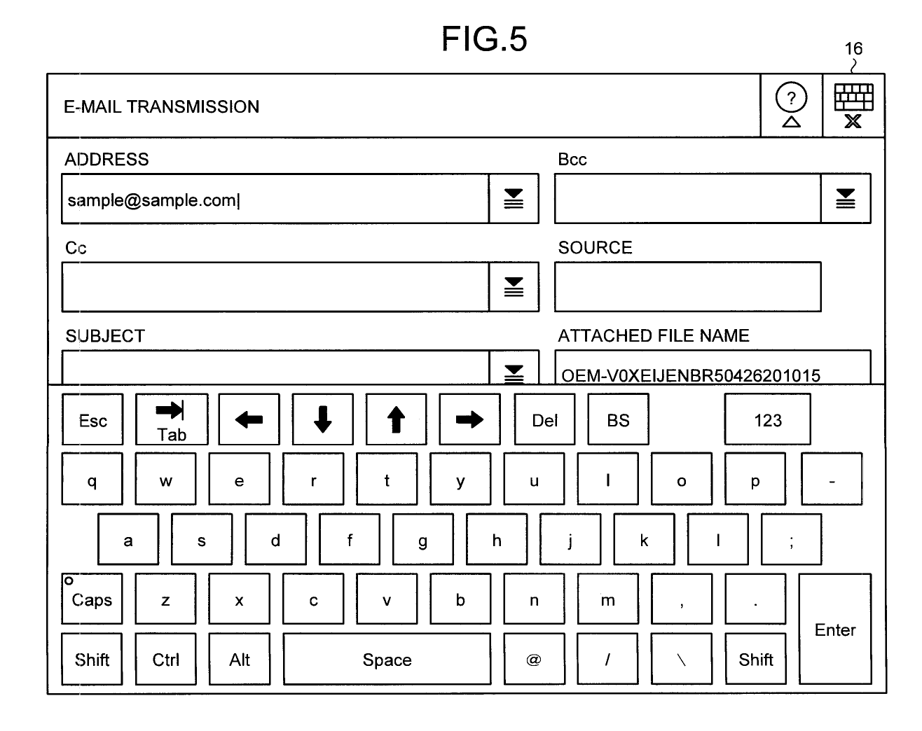

An example of the keyboard screen displayed by the keyboard displaying unit 102b according to the embodiment is explained in detail below with reference to FIG. 5. FIG. 5 is a diagram of an example of the display screen according to the embodiment.

As shown in FIG. 5, the keyboard displaying unit 102b displays the keyboard screen on the bottom part of the touch panel 114. When displaying the keyboard screen on the bottom part of the touch panel 114 such that the keyboard screen is superimposed onto the screen area, the keyboard displaying unit 102b may translucently display the keyboard screen. As shown in FIG. 5, the keyboard displaying unit 102b may display a keyboard-screen-display cancel icon 16 instead of the keyboard screen display icon 15 on the touch panel 114.

Referring back to FIG. 3, when determining at Step SB-2 that the keyboard screen is already displayed on the touch panel 114 (YES at Step SB-2), the control unit 102 determines whether the text input area for which the selection instruction is detected at Step SB-1 is different from a text input area for which a previous selection instruction is detected (Step SB-4).

When determining at Step SB-4 that the text input area for which the selection instruction is detected at Step SB-1 is not different from the previously-detected text input area (NO at Step SB-4), the control unit 102 causes the processing to proceed to Step SB-10.

On the other hand, when the keyboard screen is displayed on the bottom part of the touch panel 114 by the keyboard displaying unit 102b at Step SB-3, or when it is determined at Step SB-4 that the text input area for which the selection instruction is detected is different from the previously-detected text input area (YES at Step SB-4), the control unit 102 determines whether the text input area for which the selection instruction is detected at Step SB-1 is in the top zone in the text input area divided into the three display segments, i.e., the top zone, the center zone, and the bottom zone (Step SB-5).

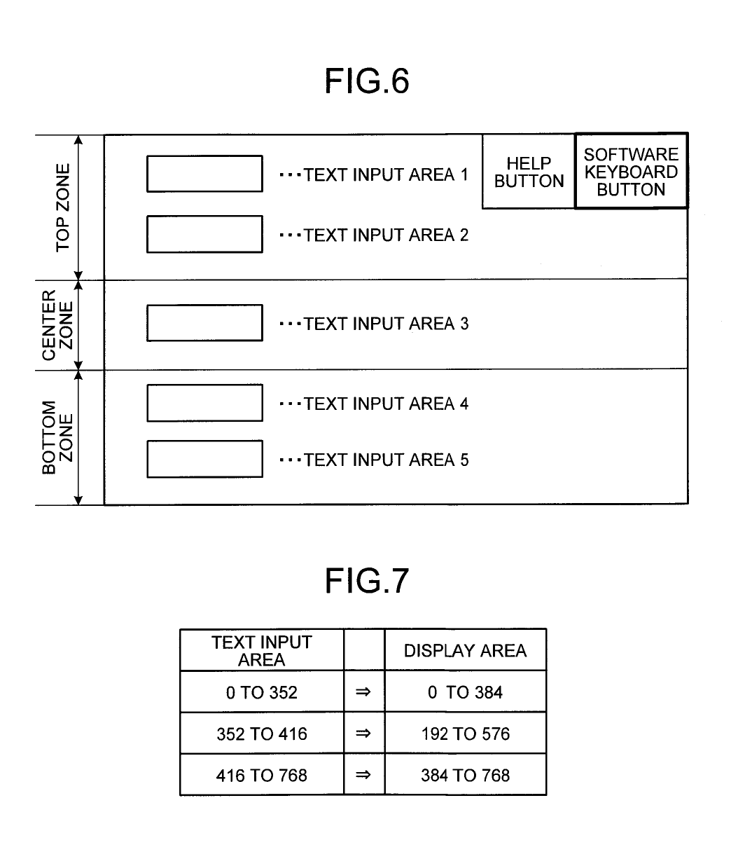

An example of a display area of the screen area corresponding to a range of coordinates of the text input area according to the embodiment is explained in detail below with reference to FIGS. 6 and 7. FIG. 6 is a conceptual diagram of an example of field segments in the screen area according to the embodiment. FIG. 7 is a diagram of an example of a display area corresponding to each range of coordinates of the text input area according to the embodiment.

As shown in FIG. 6, the screen area (field) containing text input areas 1 to 5 on the touch panel 114 is divided into the top zone containing the text input areas 1 and 2, the center zone containing the text input area 3, and the bottom zone containing the text input areas 4 and 5 (screen segmentation display method). For example, as shown in the left part of a correspondence table of FIG. 7, when the height of the screen-area screen is 768 pixels, the range of the coordinates of each text input area (field segment in the screen area) is set such that the top zone is in a range from 0 pixel at the topmost end of the screen area to 352 pixels, the center zone is in a range from 352 pixels to 416 pixels, and the bottom zone is in a range from 416 pixels to 768 pixels at the bottommost end of the screen area. As shown on the right part of the correspondence table of FIG. 7, when the coordinate of the text input area selected by the user is in the range of coordinates from 0 pixel to 352 pixels (the top zone) (e.g., the text input area 1 or the text input area 2 in FIG. 6), the screen area from 0 pixel to 384 pixels is displayed on the top area of the touch panel 114, and the keyboard screen is displayed on the remaining bottom area of the touch panel 114. Furthermore, as shown on the right part of the correspondence table of FIG. 7, when the coordinate of the text input area selected by the user is in the range of coordinates from 352 pixels to 416 pixels (the center zone) (e.g., the text input area 3 in FIG. 6), the screen area from 192 pixels to 576 pixels is lifted up and displayed on the top area of the touch panel 114, and the keyboard screen is displayed on the remaining bottom area of the touch panel 114. Moreover, as shown on the right part of the correspondence table of FIG. 7, when the coordinate of the text input area selected by the user is in the range of coordinates from 416 pixels to 768 pixels (the bottom zone) (e.g., the text input area 4 or the text input area 5 in FIG. 6), the screen area from 384 pixels to 768 pixels is lifted up and displayed on the top area of the touch panel 114, and the keyboard screen is displayed on the remaining bottom area of the touch panel 114. The lift-up display as described above and below may be performed, in the display process as described above, such that the transition state of each display area is continuously displayed until the part of the screen area containing the text input area selected by the user and the keyboard screen are placed at respective predetermined positions on the touch panel 114.

On the left part of the correspondence table of FIG. 7, the field segments in the screen area may be set such that when, for example, the text input areas are gathered in the center of the screen area, the top zone is set in a range of coordinates from 0 pixel at the topmost end of the screen area to 192 pixels, the center zone is set in a range of coordinates from 192 pixels to 576 pixels, and the bottom zone is set in a range of coordinates from 576 pixels to 768 pixels at the bottommost end of the screen area, so that the center zone can be widened.

Referring back to FIG. 3, when the control unit 102 determines at Step SB-5 that the text input area for which the selection instruction is detected is in the top zone of the screen area (YES at Step SB-5), the keyboard displaying unit 102b displays the screen area containing the text input area on the top part of the touch panel 114 (in a layout top-zone mode) so as to align the screen area and the keyboard screen displayed on the bottom part of the touch panel 114 (input filed automatic focus control) (Step SB-6), and then causes the processing to proceed to Step SB-10. That is, when the text input area is present near the top zone, the layout display based on the top zone may always be applied so as to maintain the display state in which user input is made easy.

An example of the layout top-zone (layout top) mode according to the embodiment is explained in detail below with reference to FIG. 5.

As shown in FIG. 5, when the user performs an operation of selecting the text input area of “address” in the screen area displayed on the touch panel 114 via the touch panel 114, the keyboard displaying unit 102b displays the screen area in the layout top mode. For example, when detecting that the text input area of “address” is focused on, the keyboard displaying unit 102b may display the keyboard screen (software keyboard) on the bottom part of the touch panel 114 without moving the screen area while the display of the “e-mail transmission” title is maintained on the top end. Furthermore, when, for example, the user presses the keyboard screen while the text input area of “address” is being focused on, the keyboard displaying unit 102b may lift up and display the keyboard screen on the bottom part of the touch panel 114 without moving the screen area while the display of the “e-mail transmission” title is maintained on the top end. When the display of the keyboard screen is canceled (finished), the screen area is not moved.

Referring back to FIG. 3, when determining at Step SB-5 that the text input area for which the selection instruction is detected is not in the top zone of the screen area (NO at Step SB-5), the control unit 102 determines whether the text input area for which the selection instruction is detected at Step SB-1 is in the center zone in the screen area divided into the three display segments, i.e., the top zone, the center zone, and the bottom zone (Step SB-7).

When the control unit 102 determines at Step SB-7 that the text input area for which the selection instruction is detected is in the center zone (YES at Step SB-7), the keyboard displaying unit 102b displays the screen area containing the text input area on the top part of the touch panel 114 (in a layout center-zone mode) so as to align the screen area and the keyboard screen displayed on the bottom part of the touch panel 114 (input field automatic focus) (Step SB-8), and then causes the processing to proceed to Step SB-10. That is, when the text input area is present near the center zone, the layout display based on the center zone may always be applied so as to maintain the display state in which user input is made easy.

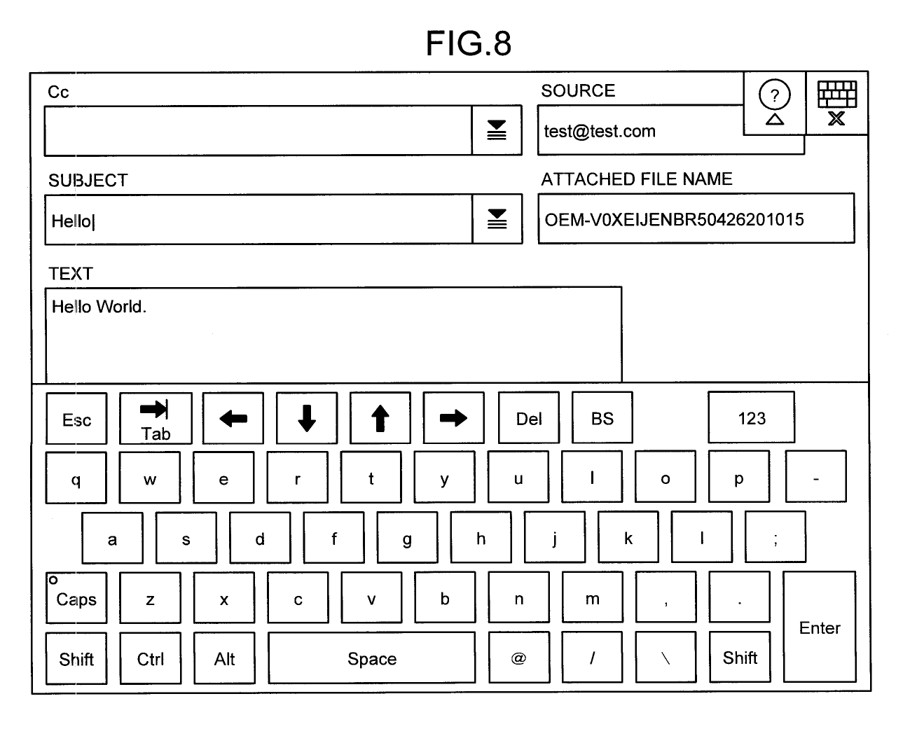

An example of the layout center-zone (layout center) mode according to the embodiment is explained in detail below with reference to FIG. 8. FIG. 8 is a diagram of an example of the display screen according to the embodiment.

As shown in FIG. 8, when the user performs an operation of selecting the text input area of “subject” in the screen area displayed on the touch panel 114 via the touch panel 114, the keyboard displaying unit 102b displays the screen area in the layout center mode. For example, when detecting that the text input area of “subject” is focused on, the keyboard displaying unit 102b may display the text input area containing “subject” on the top part of the touch panel 114 and the keyboard screen on the bottom part of the touch panel 114 while displaying the process in a lift-up display manner. Furthermore, when, for example, the user presses the keyboard screen while the text input area of “subject” is being focused on, the keyboard displaying unit 102b may display the text input area containing “subject” on the top area of the touch panel 114 and the keyboard screen on the bottom area of the touch panel 114 while displaying the process in the lift-up display manner. That is, according to the embodiment, “lift-up display” is performed such that the keyboard screen is not displayed in a superimposed manner (overwritten) on the bottom area of the screen area containing an input target portion that is to overlap the keyboard screen, whereas the input target portion of the screen area is moved and displayed so as to be lifted up. When the display of the keyboard screen is canceled (finished), the screen area may be returned (moved) to the display position (normal display mode) before move (previous position). Furthermore, the keyboard screen may be displayed by a selection operation of the keyboard screen display icon 15 (e.g., a tap operation or a press operation).

Referring back to FIG. 3, when the control unit 102 determines at Step SB-7 that the text input area for which the selection instruction is detected is not in the center zone of the screen area (NO at Step SB-7), the keyboard displaying unit 102b displays the screen area containing the text input area on the top part of the touch panel 114 (in a layout bottom-zone mode) so as to align the screen area and the keyboard screen displayed on the bottom part of the touch panel 114 (input field automatic focus control) (Step SB-9). That is, when the text input area is present near the bottom zone, the layout display based on the bottom zone may always be applied so as to maintain the display state in which user input is made easy.

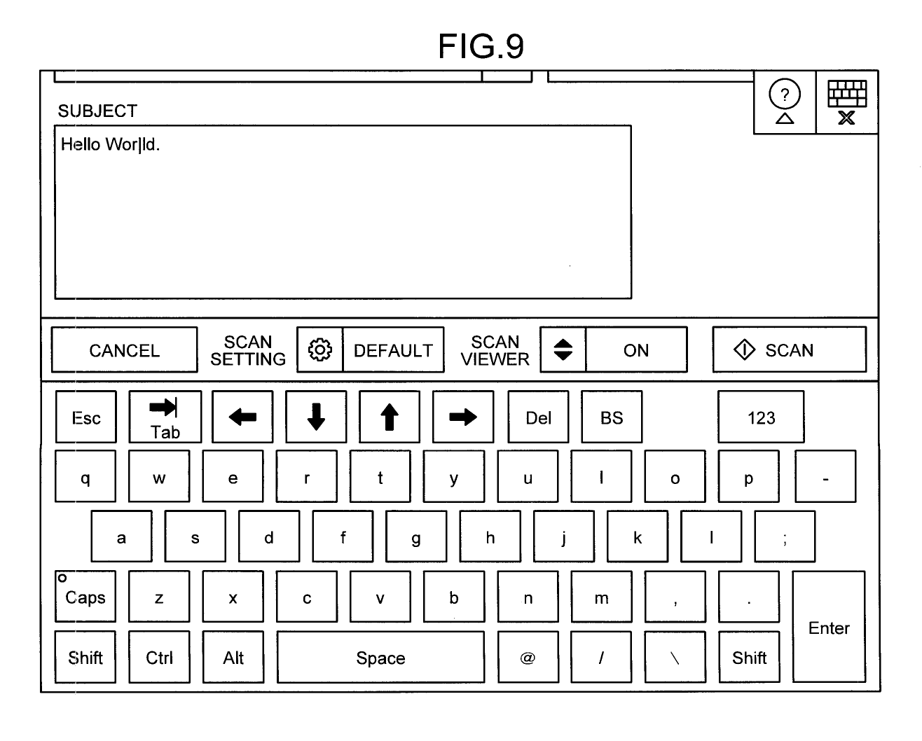

An example of the layout bottom-zone (layout bottom) mode according to the embodiment is explained in detail below with reference to FIG. 9. FIG. 9 is a diagram of an example of the display screen according to the embodiment.

As shown in FIG. 9, when the user performs an operation of selecting the text input area of “text” in the screen area displayed on the touch panel 114 via the touch panel 114, the keyboard displaying unit 102b displays the screen area in the layout bottom mode. For example, when detecting that the text input area of “text” is focused on, the keyboard displaying unit 102b may display the text input area containing “text” on the top area of the touch panel 114 and the keyboard screen on the bottom area of the touch panel 114 while displaying the process in the lift-up display manner. Furthermore, when, for example, the user presses the keyboard screen while the text input area of “text” is being focused on, the keyboard displaying unit 102b may display the text input area containing “text” on the top area of the touch panel 114 and the keyboard screen on the bottom area of the touch panel 114 while displaying the process in the lift-up display manner. When the display of the keyboard screen is canceled (finished), the screen area may be returned (moved) to the display position (normal display mode) before move (previous position).

Referring back to FIG. 3, when the user inputs character information by using the keyboard screen via the touch panel 114, the text-input-area updating unit 102c updates the display of the text input area with the character information (Step SB-10), and ends the process.

[Second Processing]

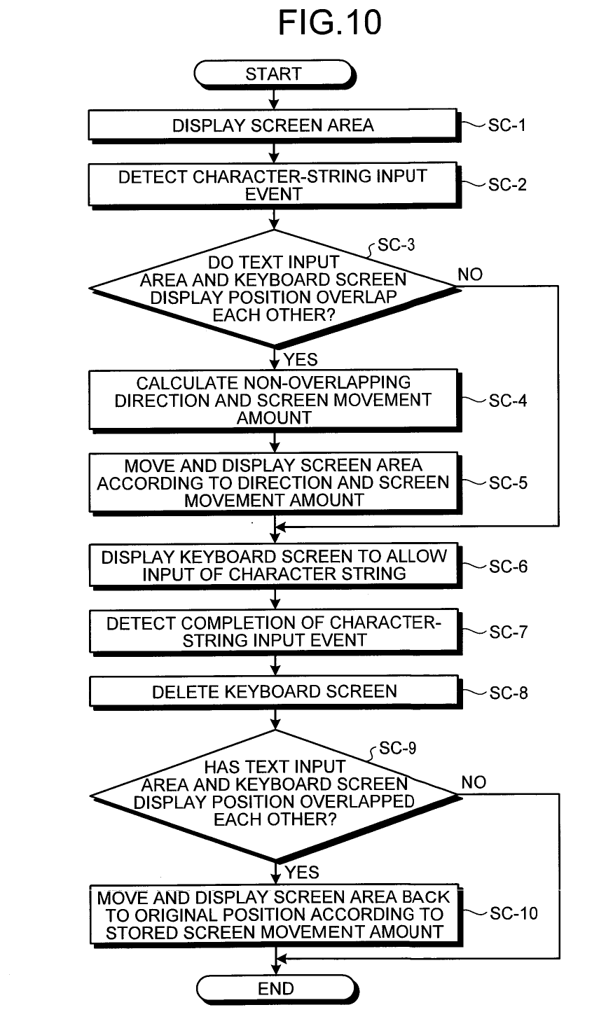

An example of processing performed by the image reading apparatus 100 according to the embodiment when a storage location name of the image file is set is explained below with reference to FIGS. 10 to 13. FIG. 10 is a flowchart of an example of processing performed by the image reading apparatus 100 according to the embodiment.

As shown in FIG. 10, the screen displaying unit 102a displays on the touch panel 114 a screen area (operation screen) containing the text input area (character-string input position) in which user input is possible (Step SC-1).

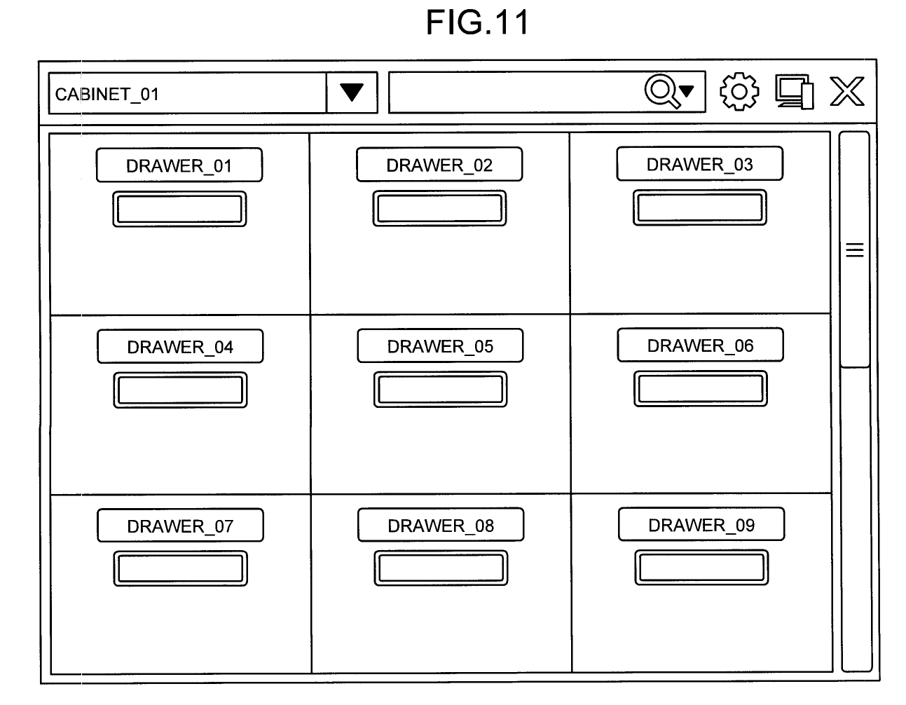

An example of the screen area displayed on the touch panel 114 according to the embodiment is explained in detail below with reference to FIG. 11. FIG. 11 is a diagram of an example of the display screen according to the embodiment.

As shown in FIG. 11, the screen displaying unit 102a displays on the touch panel 114 a list of storage location icons (drawer icons) indicating storage locations (drawers) that are stored in the storage-location-information storage unit 106a and that are storage destinations of the image file of a document read by the image reading unit 112. Specifically, the screen displaying unit 102a displays on the touch panel 114 drawer icons (drawer_01 to drawer_09) that are images of nine drawers in total in a matrix of three columns and three rows.

Referring back to FIG. 10, when the user performs, via the touch panel 114, an operation (e.g., a tap operation) of selecting the text input area containing the screen area displayed on the touch panel 114 by the screen displaying unit 102a, the control unit 102 detects the selection instruction on the text input area (character-string input event) (Step SC-2).

The control unit 102 determines whether the text input area contained in the screen area displayed on the touch panel 114 and the keyboard screen (keyboard image) display (expected) position (e.g., the bottom part of the touch panel 114) overlap each other (Step SC-3).

When determining that the text input area contained in the screen area displayed on the touch panel 114 and the keyboard screen display (expected) position do not overlap each other (NO at Step SC-3), the control unit 102 causes the processing to proceed to Step SC-6.

On the other hand, when determining that the text input area contained in the screen area displayed on the touch panel 114 and the keyboard screen display (expected) position overlap each other (YES at Step SC-3), the control unit 102 calculates a direction and a screen movement amount by which the text input area and the keyboard screen display (expected) position do not overlap each other (Step SC-4).

The keyboard displaying unit 102b moves and displays a part of the screen area containing the text input area to the top part of the touch panel 114 according to the direction and the image movement amount calculated at Step SC-4 (Step SC-5).

The keyboard displaying unit 102b displays the keyboard screen on the bottom part of the touch panel 114 so as to align the keyboard screen and the part of the screen area containing the text input area displayed on the top part of the touch panel 114, so that the user is allowed to input character information (character string) by using the keyboard screen via the touch panel 114 (Step SC-6). That is, when, for example, a character string such as a name is to be input in a specified portion on the screen area, the keyboard displaying unit 102b displays the keyboard screen on a part of the screen area (e.g., on the bottom half of the screen). When the specified portion in which the character string is to be input is hidden by the keyboard screen (e.g., when the specified portion is located on the bottom part of the screen area), the keyboard displaying unit 102b automatically moves the specified portion to a non-overlapping position so that the specified portion is not hidden by the keyboard screen, and displays the specified portion. Furthermore, for example, the screen area in which the drawer icons are displayed, text input area is present on the front face of each drawer for inputting a name for identifying the contents of each drawer. When the name of the drawer icon is to be input or changed, the keyboard displaying unit 102b displays the keyboard screen for inputting characters, so that the user is allowed to change the name or the like by touching the keyboard screen.

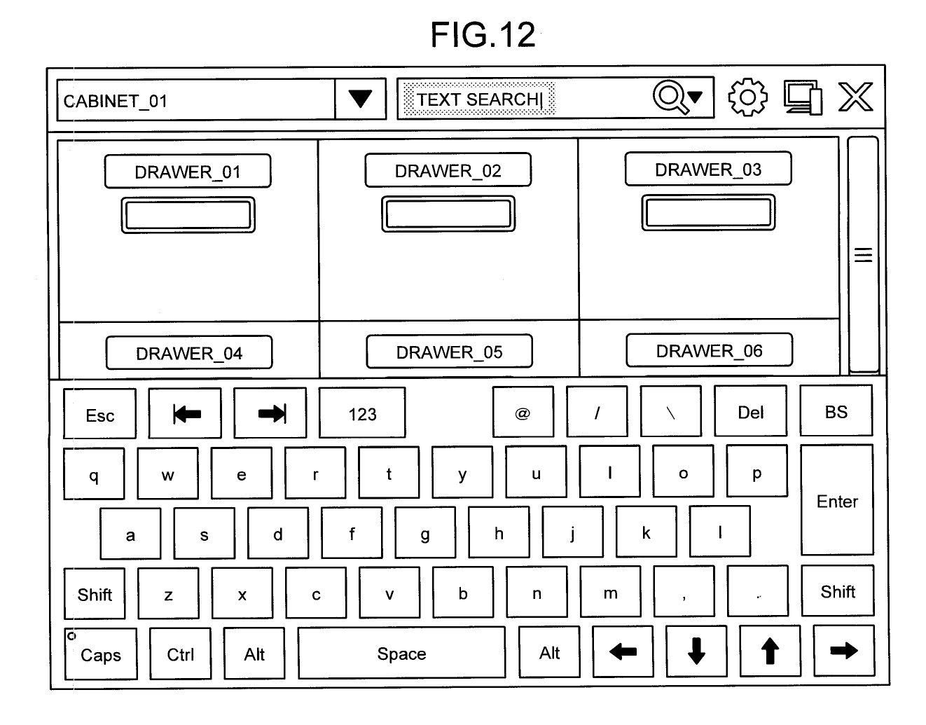

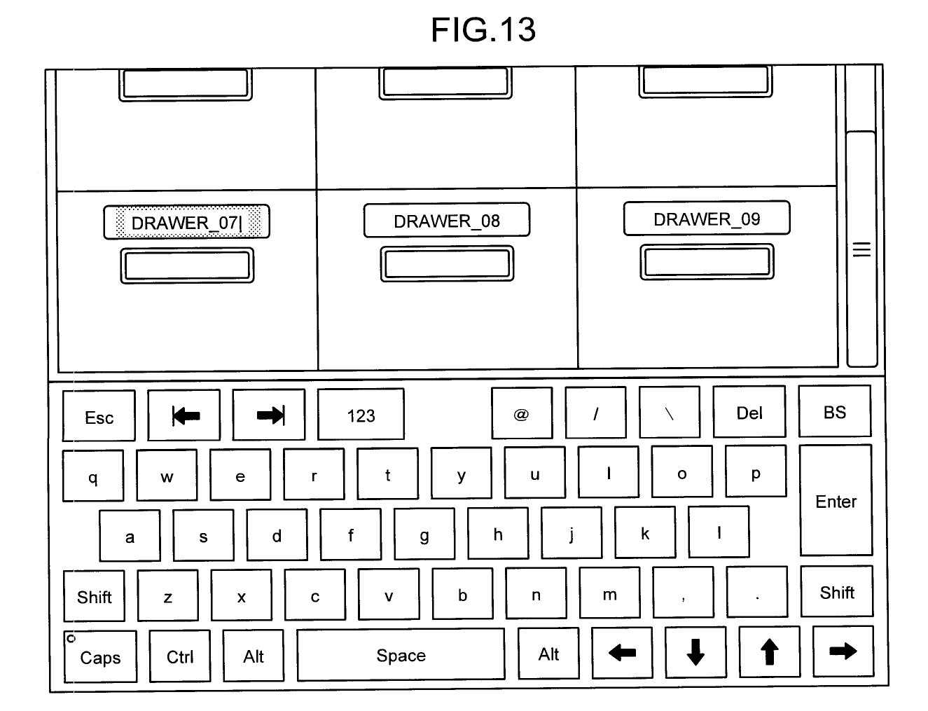

An example of the screen area displayed on the touch panel 114 according to the embodiment is explained below with reference to FIGS. 12 and 13. FIGS. 12 and 13 are diagrams of examples of the display screen according to the embodiment.

As shown in FIG. 12, when the user performs an operation of selecting a text input area for performing a text search via the touch panel 114, the text input area and the keyboard screen display position do not overlap each other. Therefore, the keyboard displaying unit 102b displays the screen area on the top part of the touch panel 114 in the same manner as the initial display, and also displays the keyboard screen on the bottom part of the touch panel 114. In FIG. 12, nine drawer icons in total in a matrix of three columns and three rows are displayed and the keyboard screen is displayed on the bottom half of the touch panel 114, so that the text input area for performing the text search and the drawer icons in the topmost layer are not hidden by the keyboard screen. Therefore, even if the keyboard screen is displayed so as to overlap the screen area, a text being input can be displayed on the drawer icon displayed on the touch panel 114 even during the keyboard input operation.

As shown in FIG. 13, when the user performs an operation of selecting a text input area of the drawer_07 via the touch panel 114, the text input area and the keyboard screen display position overlap each other. Therefore, the keyboard displaying unit 102b moves and displays the bottom zone of the screen area containing the text input area of the drawer_07 to the top part of the touch panel 114, and also displays the keyboard screen on the bottom part of the touch panel 114. In FIG. 13, when a name of the drawer is to be input in the text input areas of the drawer icons on the second row in the center of the matrix and on the third row at the bottom of the matrix, the text input areas are hidden by the display of the keyboard screen. Therefore, when the name of the drawer is to be input in the text input area of the drawer icon on the second row in the center of the matrix, the screen area may be moved and displayed upward by one drawer icon. Furthermore, when the name of the drawer is to be input in the text input area of a drawer icon on the third row at the bottom of the matrix, the screen area may be moved and displayed upward by two drawer icons. Consequently, the text input areas can be displayed without overlapping the keyboard screen, and characters being input in the drawer icon displayed on the touch panel 114 can be displayed even during the keyboard input operation. Furthermore, the screen area can be moved not only upward or downward so as not to overlap the keyboard screen, but also to the left or to the right so as not to overlap the keyboard screen.

According to the embodiment, the keyboard displaying unit 102b is allowed not to move the position of the drawer icons being a background, but to translucently display the keyboard screen to be displayed in an overlapping manner, so that even when the text input area and the keyboard screen overlap each other, a character string can be input while checking the contents. Furthermore, not only when the user inputs the name of the drawer but also when the user inputs a name of a folder or information accompanied with the image (e.g., characters for search), the display position of the text input area (character string display) can automatically be moved by detecting hiding by the keyboard screen.

That is, according to the embodiment, when the keyboard screen is displayed below the screen area on the touch panel 114 and the drawer icon in which the name is to be input is also located on the bottom part of the screen area, the drawer icon is hidden and unviewed by the keyboard screen. Therefore, when an event occurs in which a character string is to be input, the position on the screen area is detected, and when the position is hidden by the keyboard screen, the display of the screen area is moved to a position at which the position in which the character string is to be input is not hidden, so that the keyboard screen and the character string being input can simultaneously be displayed in a viewable manner.

Referring back to FIG. 10, when the character string is input by using the keyboard screen via the touch panel 114 at Step SC-6, the text-input-area updating unit 102c detects completion of the character-string input event (Step SC-7), and updates the display of the text input area with the character string.

The control unit 102 deletes the display of the keyboard screen (Step SC-8).

The control unit 102 determines whether the text input area contained in the screen area displayed on the touch panel 114 has overlapped the keyboard screen display position (Step SC-9).

When determining at Step SC-9 that the text input area contained in the screen area displayed on the touch panel 114 has not overlapped the keyboard screen display position (NO at Step SC-9), the control unit 102 ends the processing.

On the other hand, when the control unit 102 determines at Step SC-9 that the text input area contained in the screen area displayed on the touch panel 114 has overlapped the keyboard screen display position (YES at Step SC-9), the screen displaying unit 102a moves and displays the screen area back to the original position on the touch panel 114 according to the stored screen movement amount (e.g., the screen movement amount for display with move performed by the keyboard displaying unit 102b at Step SC-5) (Step SC-10), and ends the processing. That is, when the keyboard screen is deleted after the character string is input, the display of the drawer icons is moved back to the original position.

[Other Embodiment]

The embodiment of the present invention is explained above. However, the present invention may be implemented in various different embodiments other than the embodiment described above within a technical scope described in claims.

For example, an example in which the image reading apparatus 100 performs the processing as a standalone apparatus is explained. However, the image reading apparatus 100 can be configured to perform processes in response to request from a client terminal (having a housing separate from the image reading apparatus 100) and return the process results to the client terminal.

All the automatic processes explained in the present embodiment can be, entirely or partially, carried out manually. Similarly, all the manual processes explained in the present embodiment can be, entirely or partially, carried out automatically by a known method.

The process procedures, the control procedures, specific names, information including registration data for each process and various parameters such as search conditions, display example, and database construction, mentioned in the description and drawings can be changed as required unless otherwise specified.

The constituent elements of the image reading apparatus 100 are merely conceptual and may not necessarily physically resemble the structures shown in the drawings.

For example, the process functions performed by each device of the image reading apparatus 100, especially the each process function performed by the control unit 102, can be entirely or partially realized by CPU and a computer program executed by the CPU or by a hardware using wired logic. The computer program, recorded on a recording medium to be described later, can be mechanically read by the image reading apparatus 100 as the situation demands. In other words, the storage unit 106 such as read-only memory (ROM) or hard disk drive (HDD) stores the computer program that can work in coordination with an operating system (OS) to issue commands to the CPU and cause the CPU to perform various processes. The computer program is first loaded to the random access memory (RAM), and forms the control unit in collaboration with the CPU.

Alternatively, the computer program can be stored in any application program server connected to the image reading apparatus 100 via the network, and can be fully or partially loaded as the situation demands.

The computer program may be stored in a computer-readable recording medium, or may be structured as a program product. Here, the “recording medium” includes any “portable physical medium” such as a memory card, a USB (Universal Serial Bus) memory, an SD (Secure Digital) card, a flexible disk, an optical disk, a ROM, an EPROM (Erasable Programmable Read Only Memory), an EEPROM (Electronically Erasable and Programmable Read Only Memory), a CD-ROM (Compact Disk Read Only Memory), an MO (Magneto-Optical disk), a DVD (Digital Versatile Disk), and a Blue-ray Disc.

Computer program refers to a data processing method written in any computer language and written method, and can have software codes and binary codes in any format. The computer program can be a dispersed form in the form of plurality of modules or libraries, or can perform various notions in collaboration with a different program such as the OS. Any known configuration in the each device according to the embodiment can be used for reading the recording medium. Similarly, any known process procedure for reading or installing the computer program can be used.

Various databases (the storage-location-information storage unit 106a) stored in the storage unit 106 is a storage unit such as a memory device such as a RAM or a ROM, a fixed disk device such as a HDD, a flexible disk, and an optical disk, and stores therein various programs, tables, databases, and web page files used for providing various processing or web sites.

The image reading apparatus 100 may be structured as an information processing apparatus such as known personal computers or workstations, or may be structured by connecting any peripheral devices to the information processing apparatus. Furthermore, the image reading apparatus 100 may be realized by mounting software (including programs, data, or the like) for causing the information processing apparatus to implement the method according of the invention.

The distribution and integration of the device are not limited to those illustrated in the figures. The device as a whole or in parts can be functionally or physically distributed or integrated in an arbitrary unit according to various attachments or how the device is to be used. That is, any embodiments described above can be combined when implemented, or the embodiments can selectively be implemented.

According to the present invention, it is possible to display the screens without flickering and to allow the user to smoothly transition to a keyboard operation while a portion where the user is to perform the input operation is being displayed in a viewable manner.

According to the present invention, because the screen displayed on the touch panel is divided, when the user operates the text input area by using a software keyboard, the screens can be displayed according to the partitions of the screen so that the text input area cannot be hidden behind the software keyboard.

According to the present invention, the screen is not switched to a screen in a layout specific to character input, making it possible to easily recognize where and what for the character is to be input.

According to the present invention, unlike the situation in which the display of the screen area is instantly switched and changed, it is possible to allow a user to check the transition of the screen and recognize the position of the text input area in the screen area. Moreover, according to the present invention, field segments are provided, and the software keyboard is displayed in the above-mentioned lift-up display manner according to the field segments, so that it is possible to prevent screen flickering.

According to the present invention, it is possible to display a keyboard translucently, and even when the character string input portion and the keyboard are displayed in an overlapping manner, it is possible to input a character string into the character string input portion while checking the input.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading apparatus comprising:
a touch panel, a storage unit, and a control unit, wherein
the control unit includes:
a screen displaying unit that displays, on the touch panel, a screen area containing a text input area, wherein
user input is possible; and
a keyboard displaying unit that displays, when the user performs an operation of selecting the text input area via the touch panel, a part of the screen area containing the selected text input area and a keyboard screen on the touch panel.

2. The image reading apparatus according to claim 1, wherein
the screen area is made up of divided screen areas, wherein
the divided screen areas are obtained by dividing the screen area into a plurality of areas, and
the part of the screen area is a divided screen area.

3. The image reading apparatus according to claim 1, wherein
when the user performs the operation of selecting the text input area via the touch panel, the keyboard displaying unit displays the part of the screen area containing the selected text input area on the top part of the touch panel, and the keyboard screen on the bottom part of the touch panel, in an aligned manner.

4. The image reading apparatus according to claim 3, wherein
when the user performs the operation of selecting the text input area via the touch panel, the keyboard displaying unit displays the part of the screen area containing the selected text input area and the keyboard screen in a lift-up display manner, wherein
transition states of respective predetermined display areas for the part of the screen area and the keyboard screen are continuously displayed until the part of the screen area and the keyboard screen are placed on the respective predetermined display areas on the touch panel.

5. The image reading apparatus according to claim 1, wherein
when the user performs the operation of selecting the text input area via the touch panel, the keyboard displaying unit displays the part of the screen area containing the selected text input area and a translucent keyboard screen on the touch panel.

6. An image processing method executed by an image reading apparatus including:
a touch panel, a storage unit, and a control unit, wherein
the method comprising:
a screen displaying step of displaying, on the touch panel, a screen area containing a text input area, wherein
user input is possible; and
a keyboard displaying step of displaying, when the user performs operation of selecting the text input area via the touch panel, a part of the screen area containing the selected text input area and the keyboard screen on the touch panel, wherein
the steps are executed by the control unit.

7. A computer program product having a computer readable medium including programmed instructions for an image processing method executed by an image reading apparatus including: a touch panel, a storage unit, and a control unit, wherein
the instructions, when executed by a computer, cause the computer to execute:
a screen displaying step of displaying, on the touch panel, a screen area containing a text input area, wherein
user input is possible; and
a keyboard displaying step of displaying, when the user performs operation of selecting the text input area via the touch panel, a part of the screen area containing the selected text input area and the keyboard screen on the touch panel, wherein
the steps are executed by the control unit.
